(19) United States
(12) Patent Application Publication
(10) Pub. No.: US 2020/0349766 A1
(43) Pub. Date: Nov. 5, 2020

(54) Methods and Systems for Viewing and Editing AR/VR Computer-based Designs Allowing Impaired Vision Simulation

(71) Applicant: Transport Systems Catapult, Milton Keynes Buckinghamshire (GB)

(72) Inventors: Michael Calver, Milton Keynes Buckinghamshire (GB); Martin Pett, Milton Keynes Buckinghamshire (GB)

(21) Appl. No.: 16/613,756

(22) PCT Filed: May 18, 2018
(86) PCT No.: PCT/EP2018/063181

§ 371 Date: Nov. 14, 2019

(30) Foreign Application Priority Data
May 18, 2017 (GB) 1708003.7
Nov. 9, 2017 (GB) 1718555.4

(51) Int. Cl. G06T 19/00; G06T 5/00

(52) U.S. Cl. CPC G06T 19/00; G06F 3/04815; G06T 5/002

(57) ABSTRACT

A method of providing a user with a filtered image of a computer-based design, the method includes the steps of: storing, in a location accessible by a central host, master data representing the design; identifying view data corresponding to a portion of the master data representing a portion of the design to be viewed by a user; applying a filter to the view data to generate filtered view data; receiving the filtered view data at a display component of a viewer; displaying an image of the design corresponding to the filtered view data using the display component of the viewer.

### TECHNICAL FIELD OF THE INVENTION

The present invention relates to methods and systems for viewing designs using filters, which may for instance simulate various visual impairments. Of course, other types of filters may also be utilized. The invention also relates to the editing of such designs.

### BACKGROUND TO THE INVENTION

Frequently nowadays, designs are created using CAD (computer-aided design) facilities. A key feature of designs, whether they be large-scale designs, such as for buildings or outdoor environments, or smaller-scale designs such as for websites or graphical user interfaces (GUIs), is that they are accessible for a range of people of different abilities, such as wheelchair users, the blind and the deaf. It is often very challenging for a designer to view the design from the viewpoint of someone with e.g. a different level of visual acuity from himself/herself.

### SUMMARY OF THE INVENTION

Generally speaking, the present invention aims to alleviate the empathy difficulties described above, by providing methods/systems in which a user is able to view a design with a set of filters, which may be used to mimic visual impairment. Of course, the invention is in no way restricted to the simulation of visual impairments, and other filters may be used. Specifically, a first aspect of the invention provides a method of providing a user with a filtered image of a computer-based design, the method including the steps of:

(a) storing, in a location accessible by a central host, master data representing the design;

(b) identifying view data corresponding to a portion of the master data representing a portion of the design to be viewed by a user;

(c) applying a filter to the view data to generate filtered view data;

(d) receiving the filtered view data at a display component of a viewer;

(e) displaying an image of the design corresponding to the filtered view data using the display component of the viewer.

According to the present invention, the master data itself remains untouched. A filter is applied only to the view data which corresponds to a copy of a portion of the master data which representing a region of the design to be viewed by a user. By applying the filter only to the view data, rather than all of the data representing the design, less processing power is required. There is no need to perform data processing on the data which represents regions of the design which are not currently being viewed by the user. “Identification” of the view data is intended to be a broad term. For example, it may include the steps of identifying the relevant portion of the master data, and creating a copy of it, to give the view data on which subsequent processing is then performed. The key point is that the master data remains unchanged, and that the filters are not applied directly thereto.

In the present application, “view data” is data which corresponding to a view of the design from a given viewpoint. This may include the whole of the design, or may just include a portion of the design. The view data may represent an image which corresponds to what a user would see from a certain location. The view data is preferably in an electronic form which is received by the display component of the viewer, where it is rendered into a viewable image format. It must be noted that in the present application, the terms “viewer” and “display component” are not used interchangeably. The viewer refers to a whole device, only part of which, i.e. the display component, is arranged to display images or moving images. For example, the viewer may be in the form of a PC, and the display component in the form of a monitor. Or, the viewer may be in the form of a smartphone, and the display component in the form of its screen.

In some embodiments, the central host may include a processor having a filtering module, and step (c) of the method set out above may include the steps of: (i) receiving the view data at the filtering module; (ii) applying the filter to the view data using the filtering module, to generate filtered view data, and (iii) outputting the filtered view data from the filtering module, towards the viewer. In other words, in some embodiments, the filtering takes place centrally, i.e. on the central host. This is advantageous since it means that the viewer does not require as much processing power as the filtering is performed remotely on the central host.

In other embodiments, the opposite is true. Here, the viewer may include a processor having a filtering module, and wherein step (c) includes: (i) receiving the view data at the filtering module of the viewer; (ii) applying the filter to the view data using the filtering module, to generate filtered view data; and (iii) outputting the filtered view data from the filtering module, towards the display component of the viewer. This relieves the processing burden on the central host. Both embodiments such as those described in this paragraph, and those described in the previous paragraph each have their own advantages and may both be used in embodiments of the present invention.

Above, and throughout this application, we often refer to data being “received at” or “received by” e.g. the viewer. It should be stressed that this does not necessarily mean that e.g. the central host is actively sending or transmitting the data to the viewer. The term “received” should also be understood to cover the case, for example, in which the viewer accesses a storage area on e.g. the central host where the view data or filtered view data is stored (temporarily or otherwise), in order to retrieve the view data or filtered view data.

Along a similar vein, throughout this application, the term “accessible by a central host” (or similar) is used to refer to cases when e.g. the master data is stored on a cloud server connected to the central host. In other words, the master data can be, but need not be stored on the central host itself.

The important point about both of the above cases is that the filter is applied only to the view data, and not to the master data. This has advantages beyond the processing efficiency which are discussed in more detail later on in the application.

In some simple embodiments of the invention, the design may be a simple 2D design, such as for a website or a GUI. In other embodiments, the design may be a complex 3D design, such as for a building, an outdoor environment or other landscape. Many features of the present invention apply equally well to both of these types of design. We discuss these features first, before moving on to some features which are specific either to 2D designs or 3D designs.

Firstly, and importantly, the nature of the filters. As discussed earlier in the application, when preparing designs, it is highly desirable to consider the differing levels of physical ability of the eventual users of that design. As we have also alluded to, one type of physical ability which varies vastly throughout the population is eyesight. This is clearly a crucial consideration when designing buildings, products and much more. So, in preferred embodiments of the invention, the filters are used to simulate various conditions affecting eyesight, or varying levels of visual acuity.

Specifically, the step of filtering the view data may include applying a filter to the view data which simulates one or more of the following conditions: retinitis pigmentosa, glaucoma, cataracts, diabetic retinopathy, and age-related macular degeneration (both wet and dry). It should be noted that more than one of these filters may be applied at a given time. In some embodiments, the filters required to simulate these conditions are independent of the view data, and the step of filtering may include superimposing or overlaying an image over the view data. For example, with conditions such as retinitis pigmentosa, in which the field of view gradually declines, the filter may be in the form of a dark overlay with a hole in the centre, which mimics the reduced field of vision. However, in some cases, there may be an overlay, and some additional processing required, e.g. to blur the image, in order to accurately simulate the visual impairment.

Varying levels of visual acuity require more sophisticated filters. This is because the amount of “blur” a person with poor eyesight experiences is dependent on the distance of the object which the user is looking at. This means that visual acuity filters cannot be produced by using straightforward overlays. Similarly, the effect of colour-blindness on a particular view also cannot be simulated merely with an overlay, since the effect of the condition is dependent on the colour of the object at which a user is looking at a given time. In preferred embodiments of the present invention, the step of applying the filter includes applying a filter to a portion of the view data representing an object within the 3D design, wherein an effect of the filter is dependent on the distance, within the 3D design, between the location of the user within the 3D design and the object within the 3D design.

In some embodiments, in order to reduce the latency associated with having to post-process the view data (i.e. applying the filter after the view data has been generated), a filter may be applied before the view data is identified. This may be useful in the case where the filter represents e.g. a blocking out a user's view. In this case, the filter is entirely independent of the view. This may be thought of as surrounding a virtual camera in a shell which includes the filter, meaning that less view data need be identified for each frame.

Particularly in the case of filters simulating visual impairments, it is useful to allow a situation in which a user may have either different impairments in each eye and/or different levels of impairment in each eye. Accordingly, in preferred embodiments of the present invention, the step of applying a filter to the view data may include applying a left-eye filter to a portion of the view data corresponding to the viewpoint of a user's left eye, and applying a right-eye filter to a portion of the view data corresponding to the viewpoint of a user's right eye. Each of the left-eye filter and right-eye filter may simulate one or more visual impairments, and the left-eye filter may be different from the right-eye filter.

The present invention is not restricted to the simulation of visual impairments. Other filters may also applied. An example of an additional filter which may be included in the invention is a filter to change the location of light (natural or artificial) in the design. This could be used in an architectural design to give a designer an opportunity to assess different lighting schemes, or to view how a building would look at different times of day. Alternatively, for web design, such a filter may be able to mimic the effect of different types of glare on a computer screen. Similar additional filters may simulate different weather conditions, and different geographical locations or backgrounds.

The present invention is particularly useful in the field of building or outdoor space design. In such embodiments it is clearly preferable that the design is a 3D design, which may represent a 3D environment. For an improved empathetic experience, it is in turn preferred that the user is able to navigate the 3D design. By “navigate”, we mean that a user should be able to move around within that 3D design. In such embodiments, the view data changes as the location and the orientation of the user within the design change, in order to reflect the changing viewpoint. In other words, the view data depends on the location and the orientation of the user within the 3D environment. In some embodiments, the viewer may be in the form of a PC, tablet, smartphone, laptop or similar, arranged so that the user is able to navigate the 3D design using controls on the viewer, thus changing the view data. Then, the image presented on the display component at a given corresponds to the view data at that time.

In some embodiments, rather than viewing and navigating a 3D design on a 2D display of a PC, tablet, smartphone or similar, the design may be viewed by the user in a virtual reality environment. Accordingly, the viewer may be referred to as a virtual reality viewer, and the display component is in the form of a screen within that virtual reality viewer. For a more authentic experience, in which the user is able, effectively, to walk around the 3D design as if they were actually located within it, it is preferred that the virtual reality viewer is wearable. For example, the viewer may be in the form of a virtual reality headset. Alternatively, in some embodiments, the viewer may be in the form of a smartphone or tablet disposed in or on a frame or equivalent structure. In both cases, the headset or frame should be arranged so that when worn on a user's head, the display component is located immediately in front of the user's eyes, so that the user can see the image of the 3D design as if they were located within it. In preferred embodiments, the display component is arranged so that it is 40 to 70 mm away from a user's eyes when the viewer is being worn. When the viewer is worn, it is preferable that a user's hands are free. In these embodiments, the ability to have a different filter on each eye is particularly useful, since it more accurately simulates the effects of different impairments or levels of impairment in each eye.

In embodiments in which the viewer is wearable, as described in the previous paragraph, the view data is determined based on the location and orientation of the viewer. The viewer may include an accelerometer in order to detect changes in the location and orientation of the viewer.

In embodiments of the present invention, and particularly those in which the design is a large scale 3D design which is in some way navigable by a user, it is preferred that the view data is in the form of real-time data. Here, “real-time data” is used to mean that the view data is in the form of a series of frames of data, each frame corresponding to a view of a region of the design, at a given instant. As regards the frame rate, i.e. the number of times during which the view data is updated within a given time, there is a trade-off between performance and the smoothness of the moving image presented to the user. Clearly, a higher frame rate presents a more realistic view as a user moves through the design, but also requires a higher degree of processing power, and vice versa. In preferred embodiments, the frame rate is no less than 90 frames per second per eye, since below this, believability and comfort may be reduced. In other embodiments, the frame rate may be no less than 120 frames per second per eye, no less than 180 frames per second per eye, or no less than 240 frames per second per eye.

For the “real-time” embodiments as described in the preceding paragraph, it is preferred that steps (b) to (e) of the method of the first aspect of the invention are performed for each frame of data, creating a series of filtered images representing the successive frames of view data.

As the user navigates the design (e.g. by using controls on a computer keyboard/smartphone, or by walking around a virtual environment), the view data is updated to reflect the new location/orientation of a user within the design. Thus, as discussed above, the view data is based on at least one of: the location of the viewer, the orientation of the viewer, the location of the user within the 3D design, and the orientation of the user within the design. For example, when the user turns his or her head, the view data is updated to reflect the user's new head position.

The technical effects of the present invention can be greatly amplified with the inclusion of eye-tracking technology. Here “eye-tracking” refers to a process in which the direction in which a user is looking is sensed/detected/monitored. Accordingly, the viewer may be equipped with an eye-tracking device or eye-tracker arranged to track the direction in which a user is looking, to generate eye-tracking information. Alternatively, the eye-tracker may be a separate device from which the viewer is able to receive eye-tracking information. The eye-tracker may include a camera. In some embodiments, there may be an eye-tracker associated with each eye, and in other embodiments, a single eye-tracker may generate eye-tracking information for both eyes.

Employing eye-tracking allows more accurate simulation of various visual impairments, such as those in which the impairment causes a blemish in a fixed point in the sufferer's field of view, such as macular degeneration. This means that, in effect, the blemish or impairment moves relative to the objects or environment being viewed. In embodiments in which no eye-tracking is employed, the blemish may remain stationary with respect to the view, meaning that as the user scans the view with their eyes, they will be able to look around the blemish, rather than it moving with their eyes. In order to improve the invention with respect to this particular issue, in some embodiments, the view data may be identified based on eye-tracking information in addition to factors such as the location and orientation of the viewer and of the user within the design.

In embodiments such as those in which the design is viewed on a monitor of a computer or laptop, this will have the effect that the effect of the visual impairment will move across the screen depending on which portion of the screen a user is looking at, e.g. if due to macular degeneration, a user is forced to rely on their peripheral vision. This will allow more empathetic web design, for example.

In addition to an image representing the portion of the design corresponding to the (filtered) view data, the display component of the viewer may be configured to display additional features, which may be overlaid on the image being displayed at a given instant. These features may include additional information relating to the design. The additional features may also include a graphical user interface using which a user may be able to control certain aspects of the image presented to them. In preferred embodiments, the graphical user interface may include selection features such as buttons, icons or the like, representing the different filters available. For example, there may be a plurality of selection features such as buttons, icons or the like representing each of the visual impairments through which the user may view the design. In addition to the selection of the filter, or visual impairment, the graphical user interface may also include means for controlling the level of the filter, such as the severity of the visual impairment.

The crucial point here is that, according to the present invention, a user is able easily to select which filter(s) is/are applied to the view data. Furthermore, the user is able to change the filter which is in use while they are viewing, navigating or exploring the design, without having to exit the view.

Depending on the nature of the viewer, the actual selection of the selection features may differ. For example, in embodiments in which the viewer is a PC or laptop, the user may use a mouse or keyboard to select the options on a screen, the options overlaid on the view of the design. For tablets, the process may be similar, but using touchscreen features instead. In embodiments including virtual reality devices, options may be selected using gestures or similar. The user may also use a device such as a “wand”, the location and position of which is monitored, and which may be used to select features of the graphical user interface.

In addition to just viewing the design, according to some embodiments, a user may be able to edit the design during viewing. Accordingly, a second aspect of the invention provides a method for editing a computer-based design while reviewing it. Specifically, a method according to the second aspect of the invention is for editing a design, including the steps of:

(i) providing a user with a filtered image of a 3D design using the method of the first aspect of the invention (along with any optional features as set out elsewhere in the application);

(ii) receiving an editing input from a user, to generate data representing an edited portion of the design;

(iii) updating the master data corresponding to the edited portion of the design.

The display component of the viewer may include a graphical user interface, as discussed, e.g. to select the filters to be applied to the view data. In addition to selection of the filters, the graphical user interface may be further configured to receive the editing input. Specifically, the step of receiving an editing input may include receiving commands which are generated in response to a user's interaction with the graphical user interface. This may also be done using buttons, icons or the like. Alternatively, in embodiments in which virtual reality devices are used, as discussed earlier in the application, the editing input may be in the form of gestures. “Gestures” should be taken to mean any movement of the user's body, and can include gestures of a piece of hardware, such as a “wand”.

By allowing editing of the design in this way, users can edit the design “on the go”. These modifications are then eventually saved to the master data. However, the step of updating the master data need not occur immediately after the receipt of the editing input. Rather, in some embodiments, after receiving the editing input, the data representing the edited portion of the design may be cached, i.e. stored temporarily somewhere, before the master data is updated. This prevents unnecessary updating of the master data when the user may decide to undo their edit, or to make further edits. Once the design has been edited, the user may view the design having applied the filters, in order to evaluate it from the perspective of e.g. someone with a visual impairment, reduced visual acuity, as well as using filters to view the design e.g. to see how it would look at different times of day.

Accordingly, the graphical user interface may also include features enabling the user to edit the design. Enabling such functionality means that a user is able to edit the design directly in response to what they see while viewing the design without having to exit the (filtered) view of the design.

A primary advantage of the present invention, as is clear from the above, is that only a small portion of the master data need be rendered at a given time (i.e. view data identified, filter applied, and an image representing that data displayed to the user). This means that several users may view the design at a given time, each using a different viewer and a different filter. Specifically, a third aspect of the invention provides a method of providing a plurality of users with a filtered image of a computer-based design, the method including the steps of:

storing, in a location accessible by a central host, master data representing a design;

for a first viewer, performing the steps (b) to (e) of the first aspect of the invention, along with any optional features set out above; and

for a second viewer, also performing the steps (b) to (e) of the first aspect of the invention, again along with any optional features set out above.

Thus, two (or indeed more) users are able to access the design simultaneously. Furthermore, the users have different views of the design (i.e. there are separate first and second view data), and different filters may be applied for each user. For example, the design may be a 3D design of the interior of a building, which two users may each explore using separate virtual reality headsets. One user, in one area of the design may select a filter allowing them to simulate the effects of cataracts, and the other, elsewhere in the building (or in the same location) may select to simulate reduced visual acuity. The key feature of the invention which allows this is that the filter is applied at a “user level”, i.e. it is only applied to the view data. The master data remains unchanged. This means that it is possible for two users to view the design through two different filters, effectively independently of each other. It should also be noted that one user may view the environment with no filter applied—this is covered by the first aspect of the invention.

In addition only to viewing the design, according to a fourth aspect of the invention, each of the first user and the second user may be able to edit the design, in effect combining the methods of the second and third aspects of the present invention. Accordingly, a fourth aspect of the present invention provides a method of allowing a plurality of users to view and edit a computer-based design, the method including the steps of:

storing, in a location accessible by a central host, master data representing a design;

for a first user and a first viewer, performing steps (i) and (ii) of the second aspect of the invention, along with any optional features; and

for a second user and a second viewer, performing steps (i) and (ii) of the second aspect of the invention, again along with any optional features;

updating the master data corresponding to the edited portions of the design.

The optional features set out with respect to the first, second and third aspects of the invention, where compatible, apply equally well to the method of the fourth aspect of the invention. An important feature of the fourth aspect of the invention is that, where one of the first user and the second user edits the design, each of the users may be able to see the edits made by the other. In other words, similar to the optional feature set out above specifically with respect to the second aspect of the invention, after receiving the editing input from the first user, the data representing the edited portion of the design may be cached. The same applies for the second user. The location where the cached data is stored is preferably accessible by the first and second user. In other words, there is one cache which serves both of the users, so when one user edits the design, the other user is able to see those edits. This can also prevent conflict when updating the master data.

The present invention is not restricted to methods. A fifth aspect of the present invention provides a system for providing a user with a filtered image of a computer-based design, the system including:

a central host having access to a first storage area, for storage master data representing a design;

a second storage area for storing view data corresponding to a portion of the master data which corresponds to a region of the design to be viewed on a viewer;

a processing having:
a filtering module configured to apply a filter to the view data to generate filtered view data; and
a viewer configured to receive the filtered view data from the filtering module, the viewer also having a display component configured to display an image corresponding to the filtered view data.

In effect, the system of the fifth aspect of the invention is arranged to perform the methods of at least the first aspect of the invention. Accordingly, it is readily apparent to the skilled person that systems according to the fifth aspect of the present invention may include any or all of the optional features set out previously in this application, to the extent that they are compatible. For conciseness, the optional features are not repeated here.

In some embodiments of the fifth aspect of the invention, the second storage area may be located on the central host. In such cases, it is preferred that the processor including the filtering module is located at or on the central host and the filtering module is configured to: receive the view data from the second storage area; apply the filter to the view data, to generate filtered view data; and output the filtered view data towards the viewer. In these embodiments, the majority of the processing takes place on the central host, meaning that the viewer requires minimal processing capacity, and may act purely as a viewer.

In other embodiments, the second storage area may be located on the viewer. In those embodiments, the processor having the filtering module may be located on or at the viewer, and the filtering module is configured to: receive the view data from the second storage area; apply the filter to the view data, to generate filtered view data; and output the filtered view data towards the display component of the viewer. In these embodiments are spread across the central host and the viewer.

The same optional features relating to the “real-time” data, set out above with respect to the first aspect of the invention, also apply to the fifth aspect of the invention. For example, the system may include a view data generation module, configured to generate the view data based on at least one of: the location of the viewer, the orientation of the viewer, the location of the user within the design and the orientation of the user within the design.

Just as the second aspect of the invention provided a method for editing the design during viewing, a sixth aspect of the present invention provides a system for editing a computer-based design while reviewing it, the system including:
a system for providing a user with a filtered image of a computer-based design, according to the fifth aspect of the present invention (along with any optional features);
a receiving module for receiving an editing input from a user, the editing input leading to the generation of data representing an edited portion of the computer-based design.

In effect, the sixth aspect of the invention is arranged to perform the methods of at least the second aspect of the invention. Accordingly, it is readily apparent to the skilled person that systems according to the sixth aspect of the invention may include any or all of the optional features set out previously in this application, to the extent that they are compatible. For conciseness, the optional features are not repeated here.

In order to receive the editing input from a user, the system may include an input device. Input devices may include an eye-tracking module, a gesture detection module, a wand or other similar input device, or conventional computer apparatus such as a mouse, keyboard, or touchscreen. The input device may be connected wirelessly to the receiving module, e.g. via a Wi-Fi connection, via RF or via Bluetooth. Alternatively, there may be a wired connection between the input device and the receiving module.

Just as the third aspect of the invention provided a method for providing a plurality of users with a filtered image of a computer-based design, a seventh aspect of the present invention provides a system for providing a plurality of users with a filtered image of a computer-based design, the system including:
a central host having access to a first storage area for storing master data representing the design;
a second storage area for storing first view data corresponding to a first portion of the master data representing a first portion of the design to be viewed by a first user;
a third storage area for storing second view data corresponding to a second portion of the master data representing a second portion of the design to be viewed by a second user;
a first processor having:
   a first filtering module, configured to apply a first filter to the first view data to generate first filtered view data;
a first viewer configured to receive the first filtered view data from the first filtering module, the first viewer having:
   a first display component configured to display a first image corresponding to the first filtered view data;
a second processor having:
   a second filtering module, configured to apply a second filter to the second view data to generate second filtered view data;
a second viewer configured to receive the second filtered view data from the second filtering module, the second viewer having:
   a second display component configured to display a second image corresponding to the second filtered view data.

In effect, the sixth aspect of the invention is arranged to perform the methods of at least the third aspect of the invention. Accordingly, it is readily apparent to the skilled person that systems according to the seventh aspect of the invention may include any or all of the optional features set out previously in this application, to the extent that they are compatible. For conciseness, the optional features are not repeated here.

In some embodiments of the seventh aspect of the invention, the first processor and the second processor may be the same component, and may both be located on the central host. This applies to embodiments, such as have been previously described, in which all of the processing is performed by the central host, and the first and second viewers act only as passive viewers, with no active processing function (other than converting the filtered view data into a viewable image on the display component of the viewer, i.e. rendering the filtered view data).

Conversely, in other embodiments, the first processor and second processor may be separate components. Specifically, the first processor may be located on the first viewer, and the second processor may be located on the second viewer. This corresponds to a case in which the processing requirements are spread over the viewers and the central host.

Just as the fourth aspect of the invention provided a method for allowing a plurality of users to view and edit a computer-based design, an eighth aspect of the present invention provides a system for allowing a plurality of users to view and edit a computer-based design, the system including:
a central host having access to a first storage area for storing master data representing the design;
a second storage area for storing first view data corresponding to a first portion of the master data representing a first portion of the design to be viewed by a first user;
a third storage area for storing second view data corresponding to a second portion of the master data representing a second portion of the design to be viewed by a second user;
a first processor having:
   a first filtering module, configured to apply a first filter to the first view data to generate first filtered view data;
a first viewer configured to receive the first filtered view data from the first filtering module, the first viewer having:
   a first display component configured to display a first image corresponding to the first filtered view data;
a second processor having:
   a second filtering module, configured to apply a second filter to the second view data to generate second filtered view data;
a second viewer configured to receive the second filtered view data from the second filtering module, the second viewer having:
   a second display component configured to display a second image corresponding to the second filtered view data
a first receiving module for receiving a first editing input from a first user, the first editing input leading to the generation of data representing a first edited portion of the computer-based design;
a second receiving module for receiving a second editing input from a second user, the second editing input leading to the generation of data representing a second edited portion of the computer-based design.

In effect, the eighth aspect of the invention is arranged to perform the methods of at least the fourth aspect of the invention. Accordingly, it is readily apparent to the skilled person that systems according to the eighth aspect of the invention may include any or all of the optional features set out previously in this application, to the extent that they are compatible. For conciseness, the optional features are not repeated here.

Embodiments of the eighth aspect of the invention are particularly useful for 3D designs of large spaces such as buildings, landscapes and other outdoor spaces since they provide a collaborative design environment in which several designers may simultaneously explore and tweak designs, all the while being able to evaluate their designs using the filters provided for by the invention. Thus, systems according to the eighth aspect of the present invention are able to greatly improve the design process, particularly with regard to ensuring that designs are well-suited to people having different levels of physical ability.

Further optional features of the invention are set out below.

### BRIEF DESCRIPTION OF THE DRAWINGS

Embodiments of the invention will now be described by way of example with reference to the accompanying drawings in which:

FIG. 1 shows a system architecture diagram highlighting three ways in which a VR environment containing the 3D design may be accessed by users.

FIG. 2 shows a flowchart of methods employed in embodiments of the first, second, third and fourth aspects of the invention.

FIG. 3 shows a flowchart of a method to be used in some embodiments of the first aspect of the invention.

FIG. 4 shows a flowchart of an alternative method to be used in some embodiments of the first aspect of the invention.

FIGS. 5 and 6 show an example of a user's view through the display component, highlighting the interface which may be used to edit the design.

FIGS. 7 and 8 show an example of a user's view through the display component, when a filter is applied to simulate age-related macular degeneration.

FIG. 9 shows an example of a user's view through the display component, when a filter is applied to simulate glaucoma.

FIGS. 10 and 11 show examples of what may be presented on a computer monitor, when a filter is used to simulate glaucoma.

### DETAILED DESCRIPTION OF THE DRAWINGS

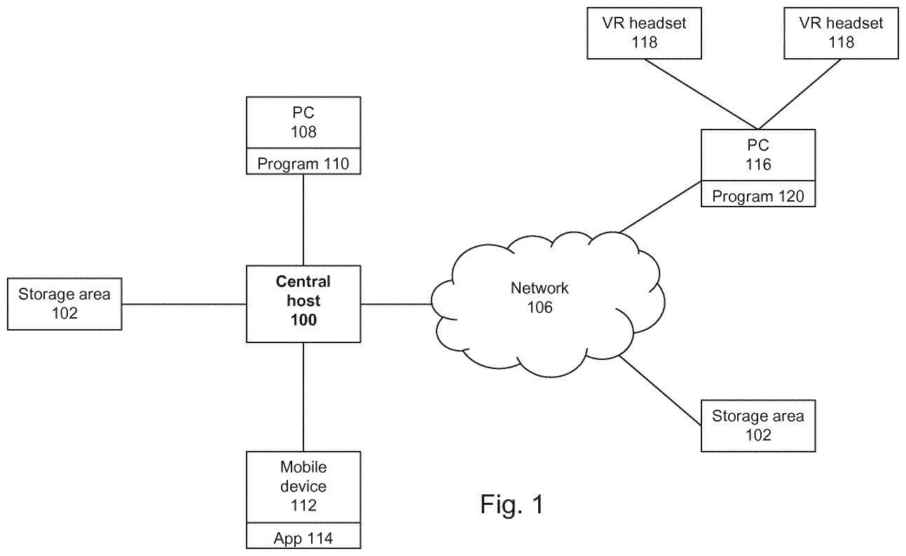

FIG. 1 shows a typical system architecture which might be employed in embodiments of the present invention. FIG. 1 illustrates three different ways by which the 3D design may be accessed by users.

Central host 100 is at the centre of the architecture, functionally speaking. Central host 100 may be in the form of a computer, server, or the like. In some embodiments, central host 100 may include a storage area (not shown) upon which the master data representing the 3D design is stored. In other embodiments, there may be a direct connection between the central host 100 and a storage area 102, on which the master data is stored. In other embodiments, the central host 100 may be connected to a storage area 104 via a network 106. This may be the case if the master data is stored on a cloud storage area 104, and the network via which the cloud storage 104 is accessed may be the internet. In other embodiments, network 106 may be a local area network, or the like.

FIG. 1 illustrates three ways in which the master data stored on one of the storage areas 102, 104 may be accessed:
In the first example, the master data may be accessed using PC 108 having loaded thereon a VR design program 110. In this case, the PC 108 represents the virtual reality display device, and the user is able to navigate the 3D design on their computer screen, and to edit it as described previously, using the VR design program 110.
Secondly, and similarly, the master data may be accessed using mobile device 112, which represents the virtual reality display device. The mobile device 112 has an application 114 loaded thereon, which allows the user to navigate and edit the 3D design using the mobile device 112. The mobile device 112 may be in the form of a smartphone or a tablet. In these embodiments, the mobile device 112 may be provided with a frame into which the mobile device 112 may be inserted. The frame is preferably configured so that it converts the mobile device 112 into a wearable headset, so that a user can place it on his or her head, with the mobile device 112 screen in front of their eyes. This may correspond to the case set out above in which the virtual reality display device is in the form of a virtual reality headset.
Finally, in the final example shown in FIG. 1, a PC 116 is connected to the central host 100 via the internet, as in the first example. The PC also includes the VR design program 120. However, in this case, two virtual reality headsets 118 are connected to the PC 116. Then, in use, a user wears one of the headsets 118 to explore and edit the 3D design. This example is effectively a mixture of the first and second examples.

The skilled person understands that the invention is in no way confined to the system architecture shown in FIG. 1, and that other layouts are possible.

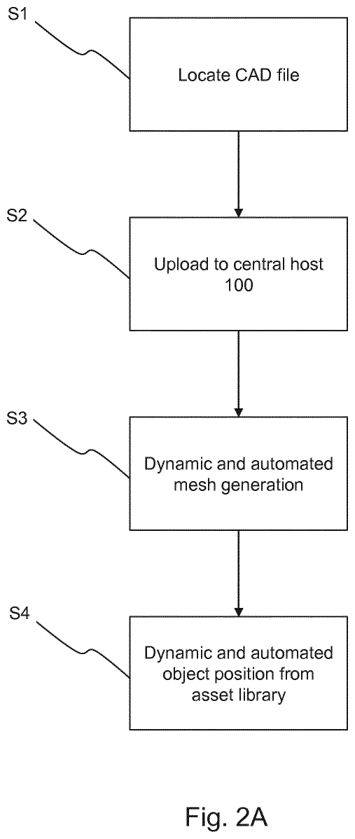

FIGS. 2A to 2D show a series of steps which may be employed when using the present invention. These are described in depth below.

In step S1, a user locates a computer-aided design (CAD) file on e.g. their PC, smartphone or tablet. The CAD file may contain a 3D design of any kind, but in the present embodiment, the CAD file is a 3D architectural design of a building. Then, in step S2 the user uploads this file to the central host 100 as shown in FIG. 1. The upload may be via the internet, or may be via a local network. Steps S3 to S7 relate to the creation of the 3D design in the virtual reality environment from the initial CAD model.

In step S8, having generated the 3D design in a virtual environment based on the CAD file uploaded in step S1, the camera start position is defined by a user. In other words, the user determines whereabouts in the design that they would like to begin their exploration. Once this is done, in step S9, the “scene” is built. This means that the virtual environment, from the viewpoint of the selected camera start position, is constructed and displayed to the user, e.g. via a virtual reality headset. Then, at step S10, the user begins to explore the environment. Given that this embodiment relates to a building design, the user may want to see how the design appears from the perspective of someone with a visual impairment. To this end, in step S11, the user may select a visual impairment using e.g. a graphical user interface displayed to him or her on the virtual reality headset. Then, in step S12 the simulation is applied. Specifically, this is done by filtering (e.g. at the host 100) the image data which is to be received by the virtual reality headset before it is displayed to the user. Then in step S13, the user continues to explore the virtual environment this time with a filtered view. Based on the simulated impairment, the user may decide that the 3D design needs editing, which is performed in step S14, e.g. by providing gestural inputs to the graphical user interface, as described in the “summary” section of this application. The changes may be saved (i.e. the master data updated) in step S15. Then, in step S16, the user may share the updated 3D design with others, who may be exploring the virtual environment at the same time.

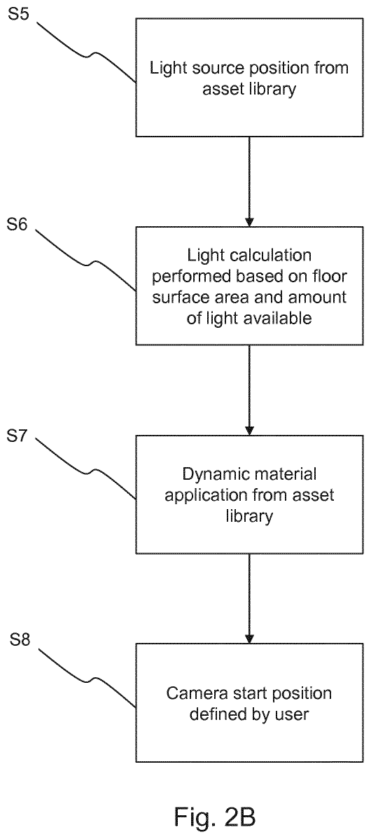

FIG. 3 shows a method which may be used in embodiments of the first aspect of the invention. The method comprises the following steps: calling a user interface within a rendered interface displayed on a computer monitor, calling a corresponding visual impairment simulation image using the user interface, through a HLSL Shader controlled by a raster image library based upon the visual impairment type selected by a user, and adjusting raster image parameters corresponding to a user's impairment severity selection; acquiring a live feed of the Computer Monitor rendered interface and displaying the processed image combined with both passive and reactive filters to visualise visual impairment simulation overlaid on the Computer Monitor rendered interface; capturing images and information from the rendered interface with the inclusion of both passive and active augmented visual impairment filters.

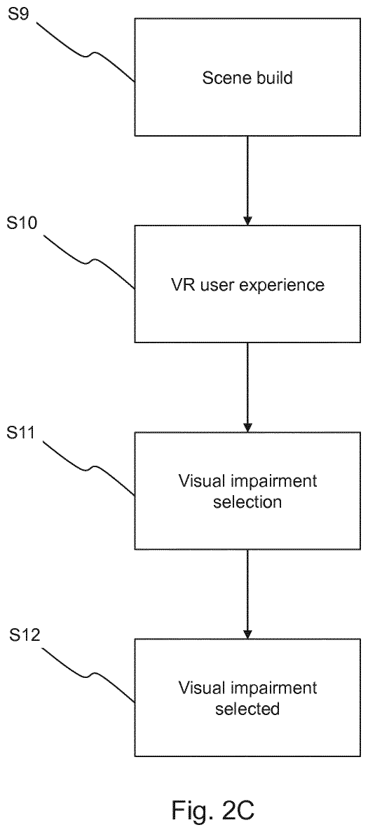

FIG. 4 shows another method which may be used in embodiments of the first aspect of the invention. The method comprises the following steps: calling a user interface within a multi-user real-time virtual environment; calling a corresponding visual impairment simulation image using the user interface, through a HLSL Shader controlled by a raster image library based upon the visual impairment type selected by a user, and adjusting raster image parameters corresponding to a user's impairment severity selection; acquiring an image feed of the multi-user real-time virtual environment and displaying the processed image of the virtual scene to visualise visual impairment simulation within the head mounted virtual reality device; making design changes to the multi-user real-time virtual environment using the acquired real-time image feed inclusive of visual impairment.

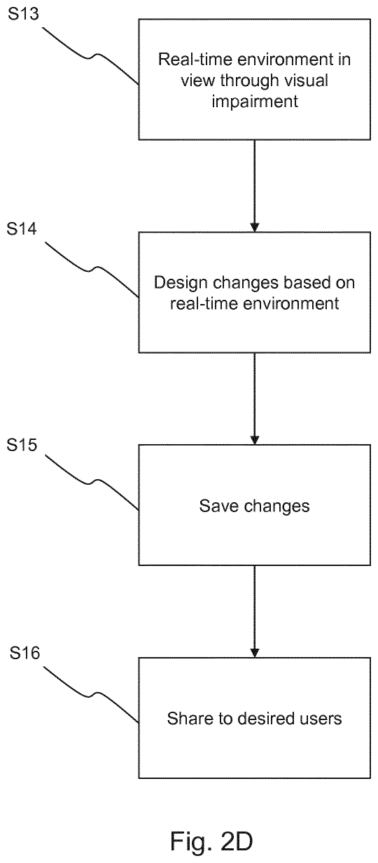

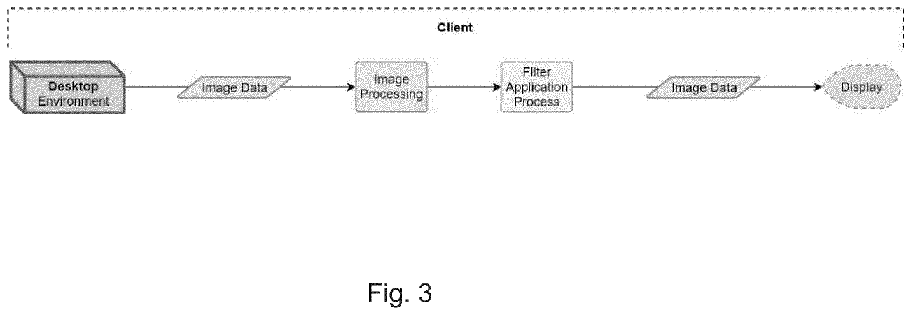

FIGS. 5 and 6 show examples of a user's view, through the display component of the present invention. Specifically, the drawings show an example of the user interface which may be displayed to the user in embodiments of the second aspect of the invention, so that the user is able to edit the environment. The user interface includes a wheel provided the user with a number of options which may be used for editing the design.

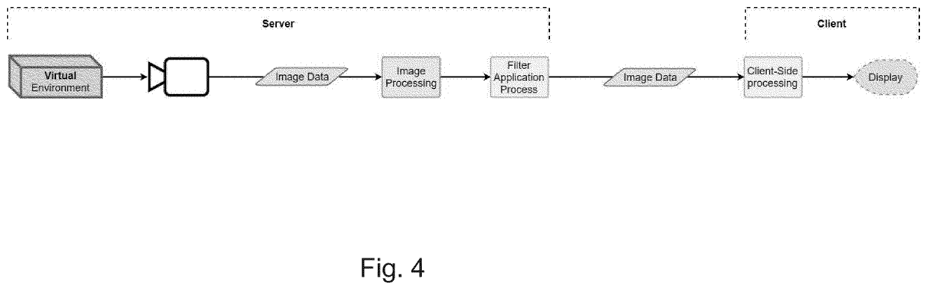

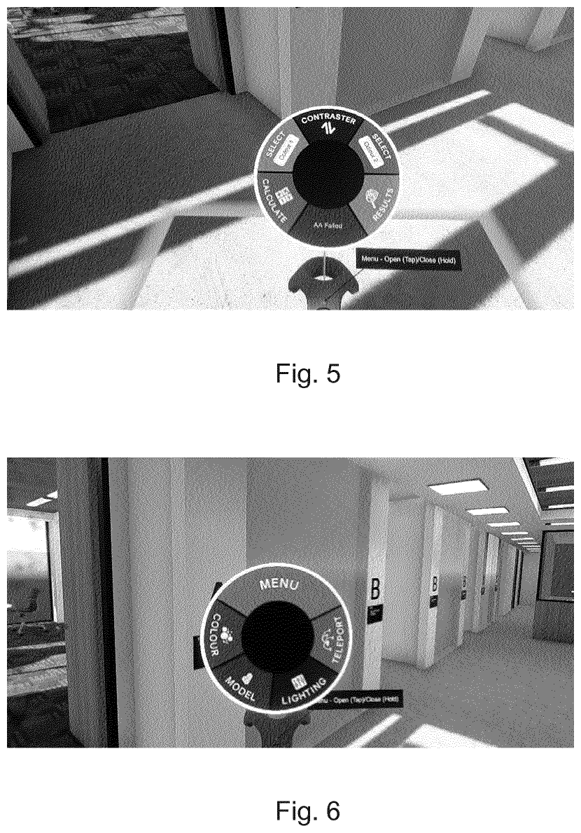

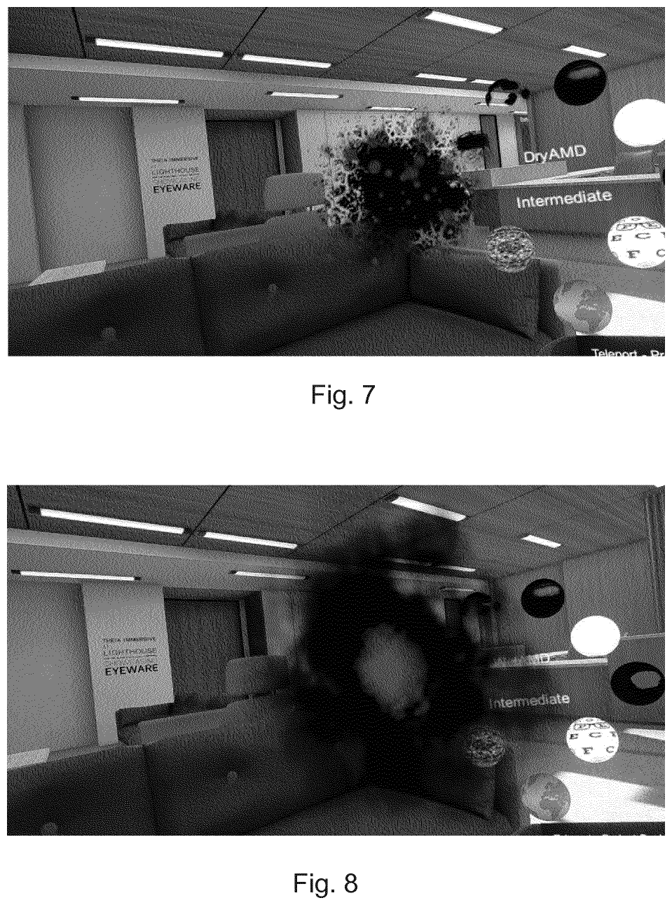

FIG. 7 shows an example of a user's view when the view data is filtered to simulate dry age-related macular degeneration within a CAD-based virtual environment. Using the wheel of options shown at the right-hand side of the image, it is possible to adjust the filter, e.g. to change the type of impairment simulated, or the degree of impairment. FIG. 8 shows something similar, except the filter is for the simulation of wet age-related macular degeneration. FIG. 9 again shows something similar, where a glaucoma filter is used.

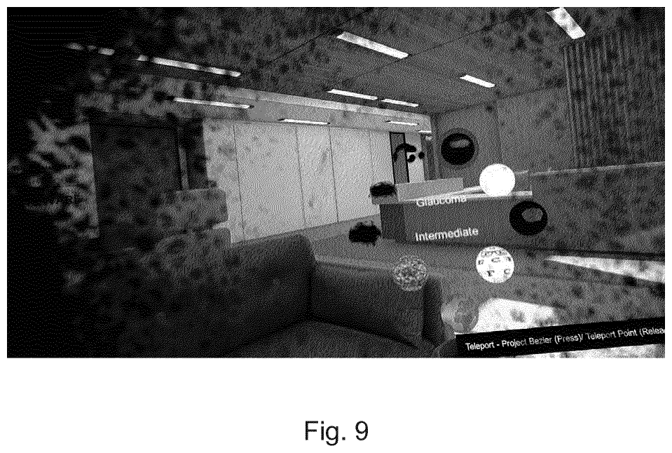

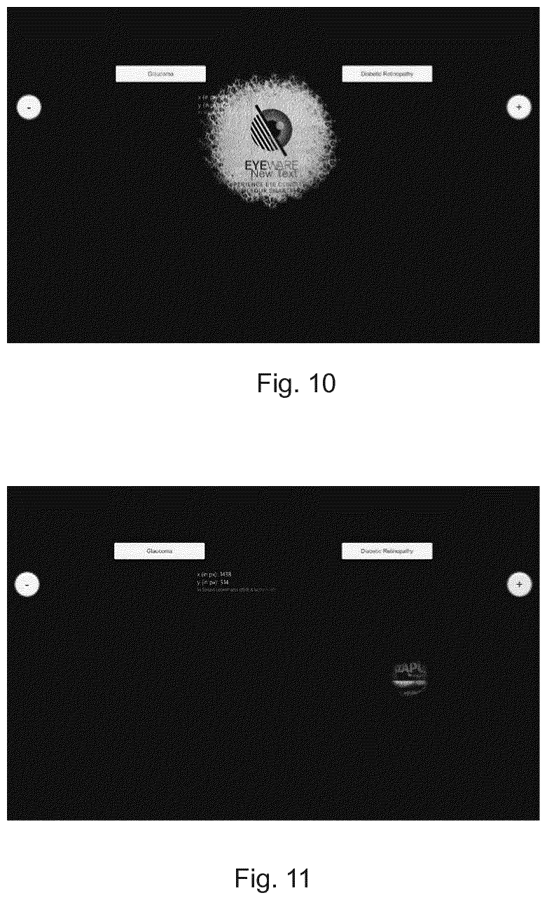

FIG. 10 shows an example in which methods of the present invention are used to view web pages displayed on a computer monitor through the eyes of a user with a visual impairment. Here, an intermediate stage of glaucoma is simulated. In FIG. 11, the degree of glaucoma is more severe. In preferred embodiments of the present invention, an eye tracking unit would be used in conjunction with the monitor. This allows the filter to move with respect to the image displayed on the computer monitor, effectively “uncovering” different parts of the webpage as the user moves their eyes.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A method of providing a user with a filtered image of a computer-based design, the method including the steps of:
(a) storing, in a location accessible by a central host, master data representing the design;
(b) identifying view data corresponding to a portion of the master data representing a portion of the design to be viewed by a user;
(c) applying a filter to the view data to generate filtered view data;
(d) receiving the filtered view data at a display component of a viewer;
(e) displaying an image of the design corresponding to the filtered view data using the display component of the viewer.

2. A method according to claim 1, wherein the central host includes a processor having a filtering module, and wherein step (c) includes the steps of:
(i) receiving the view data at the filtering module;
(ii) applying the filter to the view data using the filtering module, to generate filtered view data, and
(iii) outputting the filtered view data from the filtering module, towards the viewer, or the display component thereof.

3. (canceled)

4. A method according to claim 1, wherein the filter is configured to simulate conditions affecting eyesight, or varying levels of visual acuity.

5. (canceled)

6. A method according to claim 1, wherein the step of applying a filter takes place before the identification of view data, and wherein the filter is independent of the view data.

7. A method according to claim 1, wherein step of applying a filter to the view data includes:
applying a left-eye filter to a portion of the view data corresponding to a viewpoint of the user's left eye; and
applying a right-eye filter to a portion of the view data corresponding to a viewpoint of the user's right eye, wherein the left-eye filter is different from the right-eye filter.

8. (canceled)

9. A method according to claim 1, further including the step of eye-tracking using an eye-tracking device, wherein the view data is based, at least in part, on eye-tracking information from the eye-tracker.

10. A method according to claim 1, wherein the design is a 2D design, and the viewer is in the form of a PC, a tablet, a smartphone or a laptop.

11. A method according to claim 1, wherein the design is a 3D design.

12. A method according to claim 1, wherein:
the user is able to move around within the 3D design, and
the view data depends on either:
the location and the orientation of the user within the 3D design, or
the location and the orientation of the viewer within the 3D design.

13-14. (canceled)

15. A method according to claim 11, wherein:
the viewer is in the form of one of:
a PC,
a tablet,
a smartphone, or
a laptop; and
the user is able to navigate the 3D design using controls on the viewer, thus changing the view data.

16. A method according to claim 11, wherein the viewer is in the form of a virtual reality viewer, wherein the display component is in the form of a screen within the virtual reality viewer.

17-18. (canceled)

19. A method according to claim 11, wherein the view data is in the form of real-time data, and wherein the view data is in the form of a series of frames of data, each frame corresponding to a view of a region of the 3D design at a given instant.

20. A method according to claim 19, wherein the view data is in the form of a series of frames of data, each frame corresponding to a view of a region of the 3D design at a given instant.

21. A method according to claim 20, wherein steps (b) to (e) are performed for each frame of data, to create a series of filtered images representing successive frames of the view data.

22. A method according to claim 11, wherein:
the step of applying a filter includes applying a filter to a portion of the view data representing an object within the 3D design,
an effect of the filter is dependent on the distance, within the 3D design, between the location of the user within the 3D design and the object within the 3D design.

23.-24. (canceled)

25. A method of editing a computer-based design while reviewing it, including the steps of:
(i) providing a user with an image of a computer-based design by performing the steps of:
storing, in a location accessible by a central host, master data representing the design;
identifying view data corresponding to a portion of the master data representing a portion of the design to be viewed by a user;
applying a filter to the view data to generate filtered view data;
receiving the filtered view data at a display component of a viewer;
displaying an image of the design corresponding to the filtered view data using the display component of the viewer;
(ii) receiving an editing input from a user, to generate data representing an edited portion of the design;
(iii) updating the master data corresponding to the edited portion of the design.

26. A method according to claim 25, wherein editing input is received at a graphical user interface.

27. A method according to claim 25, wherein editing input is in the form of a gesture.

28. A method according to claim 25, wherein the data representing the edited portion of the design is cached before the step of updating the master data.

29. A method of providing a plurality of users with a filtered image of a computer-based design, the method including the steps of:
storing, in a location accessible by a central host, master data representing a design;
for a first viewer, performing the steps of:
identifying view data corresponding to a portion of the master data representing a portion of the design to be viewed by a user;
applying a filter to the view data to generate filtered view data;
receiving the filtered view data at a display component of a viewer;
displaying an image of the design corresponding to the filtered view data using the display component of the viewer; and
for a second viewer, performing the steps of:
identifying view data corresponding to a portion of the master data representing a portion of the design to be viewed by a user;
applying a filter to the view data to generate filtered view data;
receiving the filtered view data at a display component of a viewer;
displaying an image of the design corresponding to the filtered view data using the display component of the viewer.

30-34. (canceled)
